(19) United States
(12) Patent Application Publication
(10) Pub. No.: US 2017/0305345 A1
(43) Pub. Date: Oct. 26, 2017

(54) IMAGE DISPLAY CONTROL APPARATUS AND IMAGE DISPLAY SYSTEM

(71) Applicant: AISIN SEIKI KABUSHIKI KAISHA, Kariya-shi, Aichi-ken (JP)

(72) Inventors: Yoshikuni HASHIMOTO, Anjo-shi (JP); Susumu FUJITAKA, Nagoya-shi (JP); Jun AOKI, Nagoya-shi (JP)

(73) Assignee: AISIN SEIKI KABUSHIKI KAISHA, Kariya-shi, Aichi-ken (JP)

(21) Appl. No.: 15/508,268

(22) PCT Filed: Aug. 21, 2015
(86) PCT No.: PCT/JP2015/073580

§ 371 Date: Mar. 2, 2017

(30) Foreign Application Priority Data
Sep. 5, 2014 (JP) 2014-181775

(51) Int. Cl. B60R 1/00; G06T 3/20; G06K 9/00; H04N 5/232

(52) U.S. Cl. CPC B60R 1/00; H04N 5/23293; G06T 3/20; G06K 9/00805; B60R 2300/8093; B60R 2300/8046

(57) ABSTRACT

An image display control apparatus includes an image generating portion generating a display image to be displayed on a display apparatus, the display image including a mirror image of a vehicle outside image based on at least a part of a captured image in which at least a rear side of a vehicle is captured, a reference image setting portion being capable of setting a reference image corresponding to a position that is away towards the rear side of the vehicle, the reference image being set as an image to be included in the display image while the vehicle is moving forward, and a display control portion controlling the display apparatus so that the display image is displayed.

### TECHNICAL FIELD

An embodiment of this invention relates to an image display control apparatus and an image display system.

### BACKGROUND ART

Conventionally, an image processing apparatus of a vehicle is known, which generates and displays an image in a line of sight from a vehicle inside, the image in which a pillar is translucent.

### DOCUMENT OF PRIOR ART

### Patent Document

Patent document 1: JP2003-196645A

### OVERVIEW OF INVENTION

### Problem to be Solved by Invention

At this kind of apparatus, it is meaningful to obtain an image display control apparatus and an image display system with which an object including other vehicle is more recognizable.

### Means for Solving Problem

An image display control apparatus of the embodiment includes, for example, an image generating portion generating a display image to be displayed on a display apparatus, the display image including a mirror image of a vehicle outside image based on at least a part of a captured image in which at least a rear side of a vehicle is captured, a reference image setting portion being capable of setting a reference image corresponding to a position that is away towards the rear side of the vehicle, the reference image being set as an image to be included in the display image while the vehicle is moving forward, and a display control portion controlling the display apparatus so that the display image is displayed. Consequently, for example, according to the embodiment, due to the reference image, a relative positional relationship with an object, including for example other vehicle, which is positioned at the rear side of the vehicle is easily grasped.

In addition, at the above-described image display control apparatus, for example, the reference image setting portion is capable of setting at least one of the reference image corresponding to the position that is away towards the rear side of the vehicle and a reference image showing a rear portion of a vehicle body, the reference image (Imr, Imi) being set as the image to be included in the display image while the vehicle is moving forward. Consequently, for example, due to the reference image, the relative positional relationship with the object, including for example other vehicle, positioned at the rear side of the vehicle is more easily grasped.

In addition, at the above-described image display control apparatus includes, for example, an attention region image setting portion being capable of setting an attention region image which is positioned at at least one of a right side and a left side of the reference image in the display image and shows an attention region corresponding to an obliquely rear side of the vehicle, the attention region image being set as an image to be included in the display image. Consequently, for example, due to the attention region image, it is easily grasped that the object including other vehicle exists at the obliquely rear side of the vehicle.

In addition, at the above-described image display control apparatus, for example, includes an object detection portion detecting an object, and the attention region image setting portion setting the attention region image in a case where the object is detected at a position corresponding to the attention region by the object detection portion. Consequently, for example, in a case where the object does not exist and thus necessity of the attention region image is low, the attention region image is not displayed.

In addition, at the above-described image display control apparatus, for example, the attention region image setting portion sets the different attention region image depending on a position of the detected object. Consequently, because the attention region image changes, it is more easily grasped that the object including other vehicle exists at the obliquely rear side of the vehicle, for example.

In addition, an image display system of the embodiment includes, for example, an image capture portion capturing at least a rear side of a vehicle, a display apparatus, and an image display control apparatus, wherein the image display control apparatus includes an image generating portion generating a display image to be displayed on the display apparatus, the display image including a vehicle outside image based on at least a part of a captured image captured by the image capture portion, a reference image setting portion being capable of setting a reference image showing a position that is away towards a rear side of a vehicle body, the reference image being set as an image to be included in the display image while the vehicle is moving forward, and a display control portion controlling the display apparatus so that the display image is displayed. Consequently, according to the embodiment, due to the reference image, a relative positional relationship with the object including, for example, other vehicle, positioned at the rear side of the vehicle is easily grasped, for example.

### BRIEF DESCRIPTION OF DRAWINGS

FIG. 1 is an exemplary schematic configuration diagram of an image display system of an embodiment.

FIG. 2 is a diagram indicating an example of a display image by the image display system of the embodiment.

FIG. 3 is a diagram indicating another example of the display image by the image display system of the embodiment.

FIG. 4 is a plan view of an example of an image capture range by an image capture portion of the image display system of the embodiment.

FIG. 5 is a side view of an example of the image capture range by the image capture portion of the image display system of the embodiment.

FIG. 6 is a diagram indicating an example of a vehicle outside image included in the display image by the image display system of the embodiment.

FIG. 7 is a diagram indicating an example of a vehicle body image added by the image display system of the embodiment.

FIG. 8 is a plan view of another example of the image capture range by the image capture portion of the image display system of the embodiment.

FIG. 9 is a side view of another example of the image capture range by the image capture portion of the image display system of the embodiment.

FIG. 10 is a diagram indicating an example of a display range in the vehicle outside image at the image display system of the embodiment.

FIG. 11 is an exemplary block diagram of an ECU included in the image display system of the embodiment.

FIG. 12 is an exemplary flowchart of procedures of the image display system of the embodiment.

FIG. 13 is a diagram indicating an example of an output image by the image display system of the embodiment.

FIG. 14 is a diagram indicating another example of the output image by the image display system of the embodiment.

FIG. 15 is a diagram indicating still another example of the output image by the image display system of the embodiment.

FIG. 16 is a diagram indicating still another example of the output image by the image display system of the embodiment.

FIG. 17 is a diagram indicating still another example of the output image by the image display system of the embodiment.

FIG. 18 is a diagram indicating still another example of the output image by the image display system of the embodiment.

FIG. 19 is a diagram indicating still another example of the output image by the image display system of the embodiment.

FIG. 20 is a diagram indicating still another example of the output image by the image display system of the embodiment.

FIG. 21 is a diagram indicating still another example of the output image by the image display system of the embodiment.

FIG. 22 is a diagram indicating still another example of the output image by the image display system of the embodiment.

FIG. 23 is a diagram indicating still another example of the output image by the image display system of the embodiment.

FIG. 24 is a diagram indicating still another example of the output image by the image display system of the embodiment.

FIG. 25 is a diagram indicating still another example of the output image by the image display system of the embodiment.

FIG. 26 is a diagram indicating still another example of the output image by the image display system of the embodiment.

FIG. 27 is a diagram indicating still another example of the output image by the image display system of the embodiment.

### MODE FOR CARRYING OUT THE INVENTION

An exemplary embodiment and an exemplary variation of the invention will be hereinafter disclosed. Configurations of the following embodiment and variation, and operations, results and effects brought by the configurations are examples. The invention can be achieved with other configuration than the configurations disclosed in the following embodiment and variation. In addition, according to the invention, at least one of various effects and derivative effects which are obtained by the configurations can be obtained.

In addition, similar constitutional elements are included in the embodiment and examples which are disclosed below. In the following, the similar constitutional elements are designated with common numerical reference and explanations thereof will not be repeated.

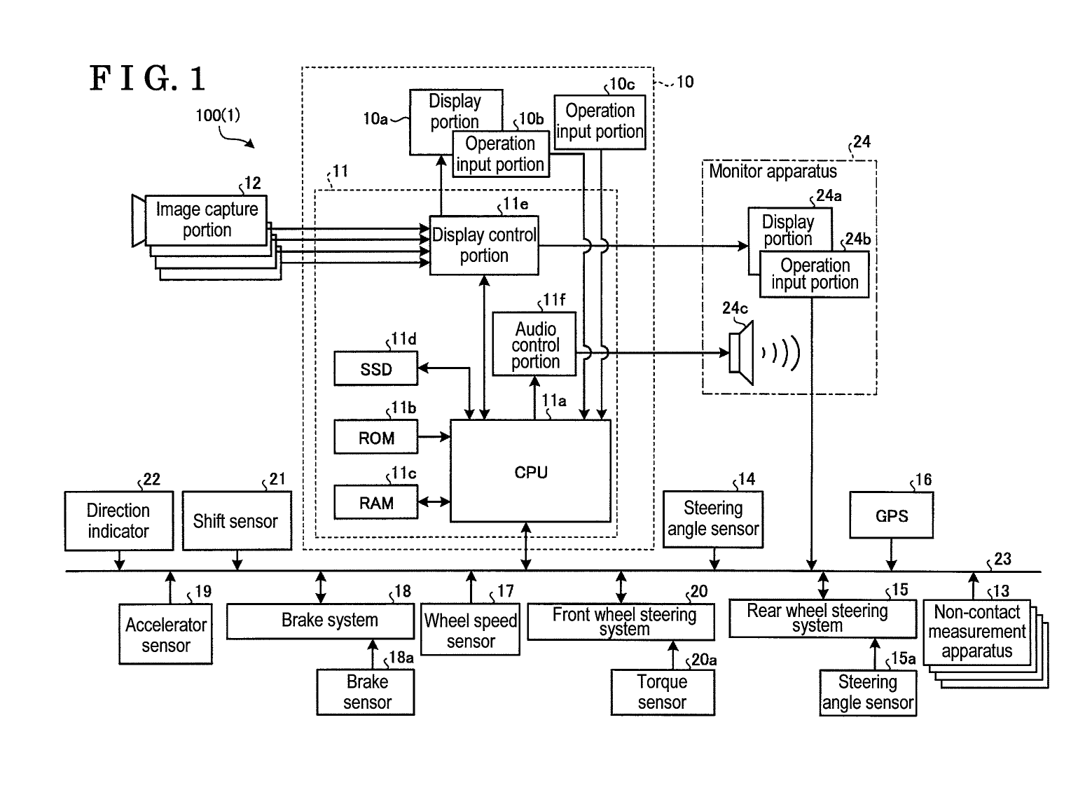

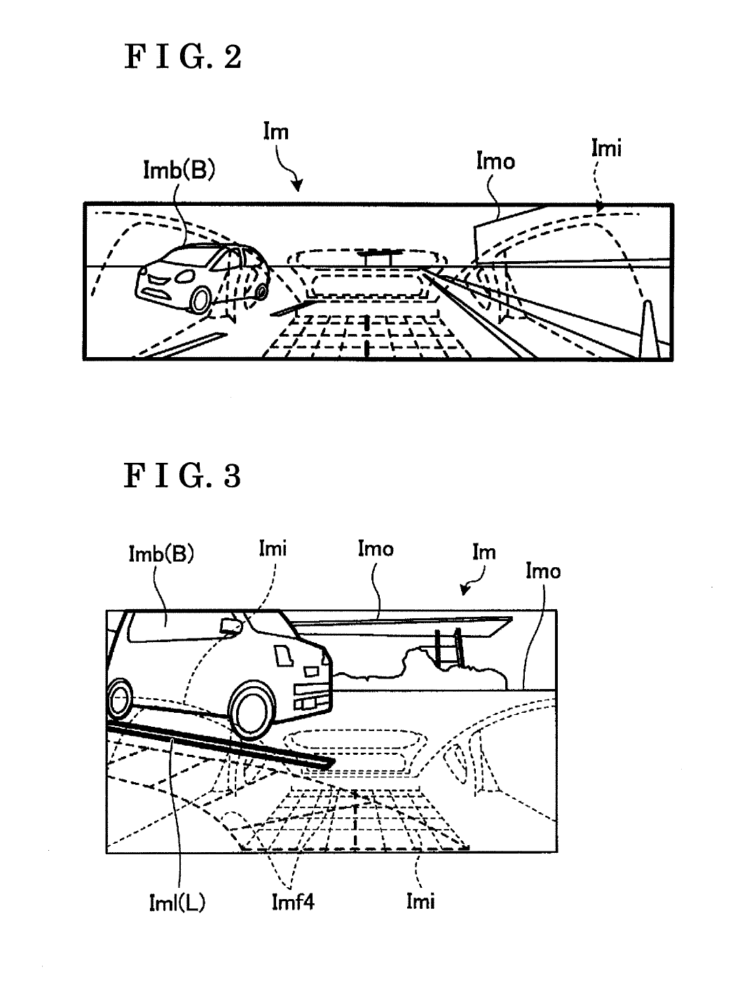

An image display system 100 mounted on a vehicle 1 includes an ECU 11 (electronic control unit) controlling an image displayed at a display portion 10a serving as a display apparatus, as illustrated in FIG. 1. The ECU 11 is an example of a display control portion or an image display control apparatus. For example, the display portion 10a is provided instead of a rearview mirror or a room mirror, which is not shown, provided at a front upper portion inside a vehicle cabin for visual recognition of a rear side. As shown in FIG. 2, an image resembling a mirror image reflected in the rearview mirror provided at the front upper portion inside the vehicle cabin is displayed at the display portion 10a on the basis of an image captured or imaged at an image capture portion 12. An occupant, including a driver, for example, may use the display portion 10a as the rearview mirror or instead of the rearview mirror. The rearview mirror can also be referred to as a back mirror.

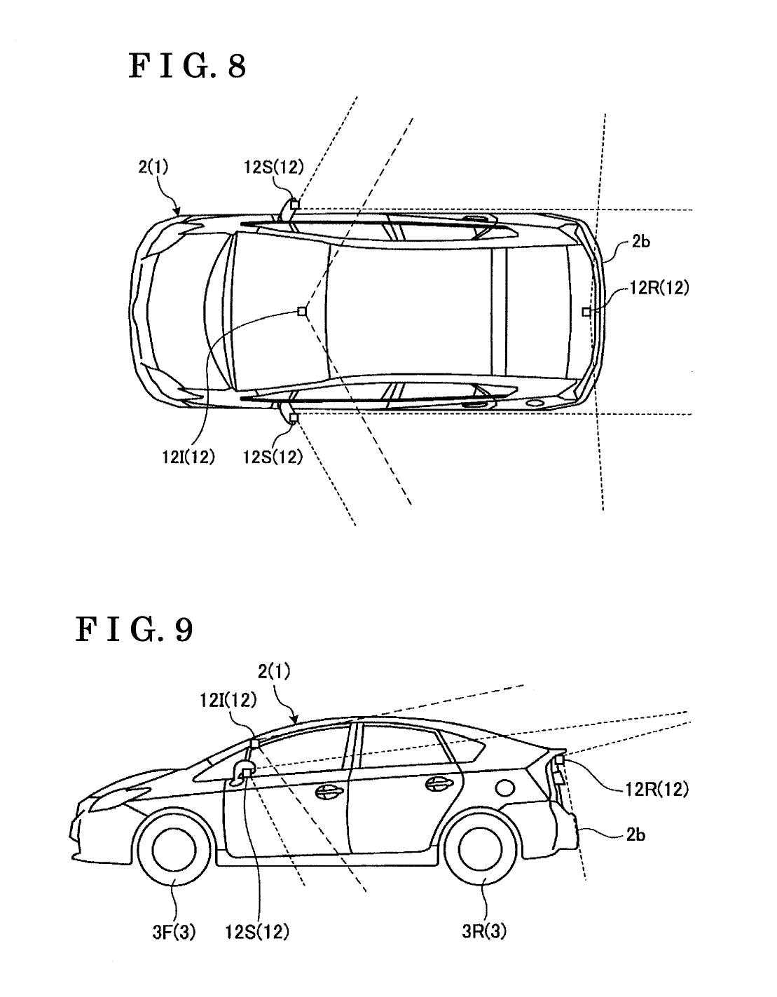

In a case where the vehicle 1 is provided with the rearview mirror, the display portion 10a of a housing 10 may be attached to the rearview mirror with, for example, an attachment and/or a fitting in such a manner that the display portion 10a covers a mirror surface of the rearview mirror. On the display portion 10a, a right-left reversal image of an image captured at the image capture portion 12 provided outside the vehicle, that is, outside the vehicle cabin, is displayed. That is, the mirror image is displayed on the display portion 10a. The display portion 10a can be configured as an LCD (liquid crystal display), an OELD (organic electro-luminescent display) and/or a projector apparatus, for example. The ECU 11 may be accommodated in the housing 10 of the display portion 10a or may be accommodated in the housing 10 provided at a separate position from the display portion 10a. A half mirror, which is not shown, may be provided at a front surface side, that is, a rear side, of the display portion 10a. In this case, in a state where the image display system 100 is not being used and no image is displayed on the display portion 10a, the half mirror can be used as the rearview mirror. In addition, a portion of the half mirror can be used as the rearview mirror, the portion which covers a region where the display portion 10a does not partly display the image, for example, a black-out region. In addition, an image capture portion 121 shown in FIG. 8 and FIG. 9 and capturing a cabin interior image may be provided at the housing 10.

As illustrated in FIGS. 2 and 3, an output image Im serving as the image displayed at the display portion 10a includes a vehicle outside image Imo indicated by the continuous line and a vehicle body image Imi indicated by the dashed line. The vehicle outside image Imo can be generated from the image captured by the image capture portion 12 or plural image capture portions 12. The output image Im can also be referred to as a display image. The vehicle outside image Imo, that is, the image captured or taken by the image capture portion 12, can also be referred to as a captured image. In addition, the vehicle body image Imi can also be referred to as an additional image. For example, in FIG. 2, for distinguishing from the vehicle outside image Imo in the drawing, the vehicle outside image Imo is indicated by the continuous line and the vehicle body image Imi is indicated by the dashed line for the purpose of convenience. The actual vehicle outside image Imo is not limited to the continuous line and the actual vehicle body image Imi is not limited to the dashed line. The vehicle body image Imi is an example of a reference image and is also an example of the additional image.

The image capture portion 12 is a digital camera including therein an imaging element including a CCD (charge coupled device) and/or CIS (CMOS image sensor), for example. The image capture portion 12 can output image data, that is, moving-image data, at a predetermined frame rate.

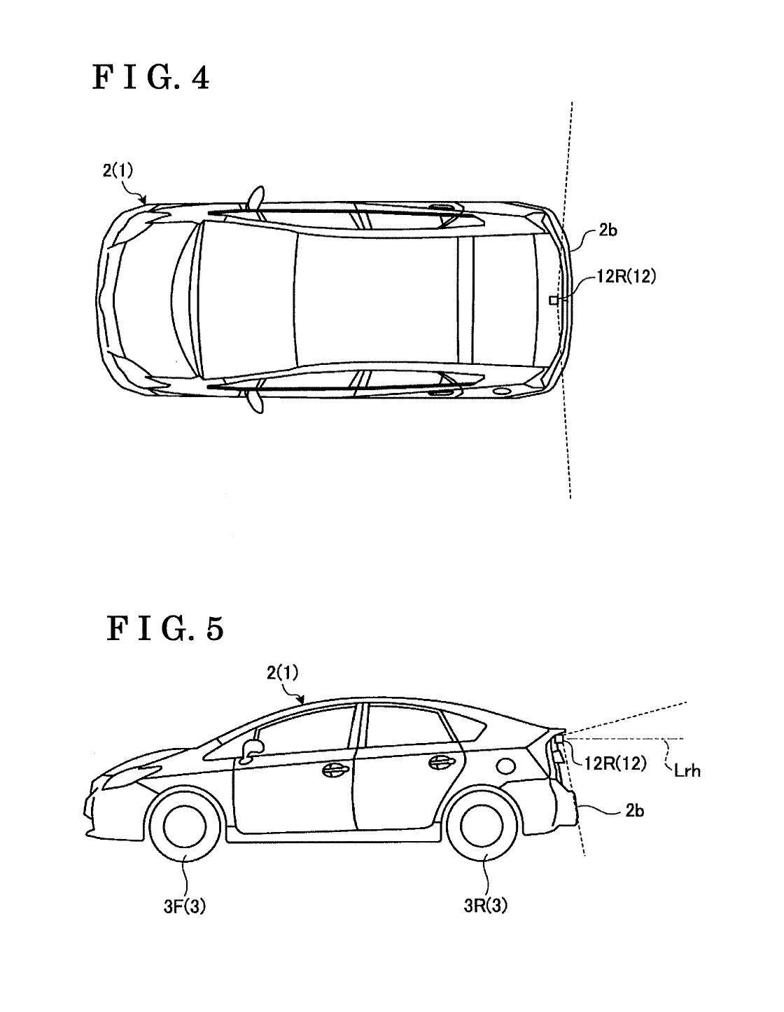

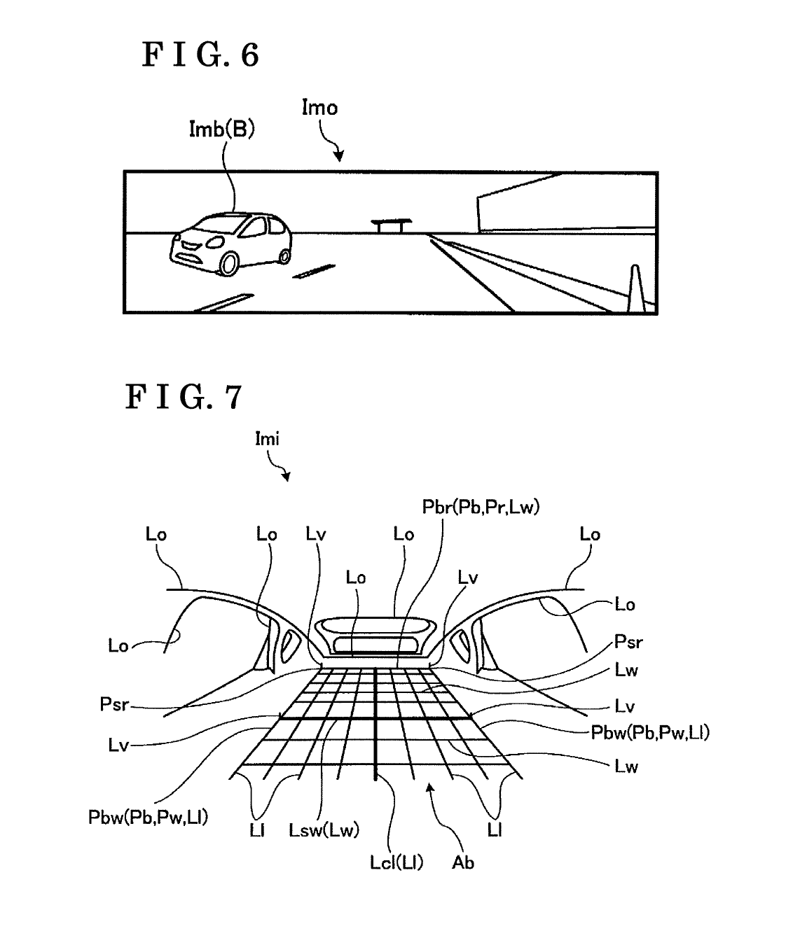

In the example of FIGS. 4 and 5, as the image capture portion 12 capturing the vehicle outside, only an image capture portion 12R is provided at a rear portion of a vehicle body 2. The image capture portion 12R captures or images the rear side and a lateral side of the vehicle 1, that is, the rear side and the lateral side of the outside of the vehicle cabin. The image capture portion 12R is a wide-angle lens or a fish-eye lens, for example. In this case, as indicated by the dashed line in FIG. 5, a capture range or an imaging range of the image capture portion 12R is set to include at least a range from a direction in which a rear end portion 2b of the vehicle body 2 is captured to an upper side than a horizontal direction Lrh at the rear side relative to the vehicle 1. Thus, both of an image of the vehicle rear side during running and an image of the vicinity of a road surface at the vehicle rear side during being stopped can be obtained from the captured image taken by the image capture portion 12R. The image capture range illustrated in FIGS. 4 and 5 is an example and the image capture range of the image capture portion 12R is not limited to the example of the FIGS. 4 and 5. FIG. 6 shows an example of the vehicle outside image Imo obtained from the captured image by the image capture portion 12. Here, the horizontal direction Lrh is a horizontal direction with reference to the vehicle 1 and is a direction which is even or horizontal when the vehicle 1 is positioned at a horizontal surface.

In addition, in the examples of FIGS. 2, 3 and 7, the vehicle body image Imi includes an outline Lo or an edge which serves as a display element drawn in a form of a three-dimensional frame shape indicating a structure of the vehicle body 2. Vehicle body structural elements indicated with the outline Lo include, for example, a corner portion, an edge portion, a window, a pillar, a door, a floor, a ceiling, a trim, a wheel, an axle and a differential gear of the vehicle body 2. The vehicle body image Imi does not necessarily need to be a shape of the vehicle body itself, as long as the occupant can recognize the position and/or the shape of the vehicle body 2 broadly. The vehicle body image Imi may be schematic. A region between the outlines Lo may be colored in such a manner that the vehicle outside image Imo transmits therethrough.

In addition, in the examples of FIGS. 2, 3 and 7, the vehicle body image Imi is a line image (a line view). A line serving as the display element and included in the line image may include various display manners. The display manners include a kind, an area density, a width, a thickness, a color density, a transmittance, a color and a pattern, for example. The kind includes a continuous line, a dashed line, a long dashed short dashed line, a long dashed double-short dashed line, a polygonal line, a zigzag line and a wavy line, for example. The area density is a density per unit area of a screen or of the image. The area density is a degree of density per unit area of a screen or of an image. For example, in a case where a continuous line and a dashed line include the same thickness, the area density of the continuous line is larger than the area density of the dashed line. In addition, the line image may include plural lines of which the display manners are different locally. In addition, the line image may partly include a point or dot, a sign, a letter of character, and graphics or figure, for example. The display manners of the line image can be set and be changed in accordance with a vehicle status including a running status and an operation status, for example.

As illustrated in FIGS. 2 and 3, the output image Im including the vehicle outside image Imo and the vehicle body image Imi is displayed on the image display portion 10a, and accordingly the occupant easily recognizes relative positions of the vehicle 1 and an object B outside the vehicle relative to each other, a distance between the vehicle 1 and the object B, a direction of the object B and a size of the object B, for example. In addition, as illustrated in FIGS. 2, 3 and 7, the vehicle body image Imi may include a portion Pw indicating an end portion of the vehicle body 2 in a vehicle width direction, a portion Pr indicating a rear end portion of the vehicle body 2 and a portion Pb indicating a lower portion of the vehicle body 2. Further, the vehicle body image Imi may include a portion Pbw indicating an end portion of the lower portion of the vehicle body 2 in the vehicle width direction, a portion Pbr indicating a rear end portion of the lower portion of the vehicle body 2 in a vehicle front and rear direction and a portion Psr indicating a rear end portion of a side portion of the vehicle body 2 in the vehicle front and rear direction, for example. In addition, the vehicle body image Imi is made such that at least the lower portion of the vehicle body 2 is recognizable in a planar manner, that is, a two-dimensional manner. Accordingly, the occupant easily recognizes, for example, a planar size, a planar shape and a planar portion of the vehicle body 2. In addition, for example, the occupant easily recognizes a size and a height of the object B outside the vehicle cabin and a positional relationship of the object B in the horizontal direction with reference to the vehicle body image Imi.

The vehicle body image Imi is stored at a non-volatile storage portion in advance. The vehicle body image Imi for each of plural vehicle types can be stored at the storage portion. In this case, the vehicle body image Im which is selected according to the vehicle type of the vehicle 1 and/or a taste of the user can be used as a composite image, for example. The storage portion may be an SSD 11d illustrated in FIG. 1, for example. The ECU 11 can deform the vehicle body image Imi on the basis of an input instruction and/or operation at an operation input portion 10b during a setting work including, for example, calibration. Specifically, for example, the vehicle body image Imi is deformed to be expanded to right and left towards the upper side, to be expanded to up and down, or the positions of right, left, up and down are changed, or the position of the vehicle body image Imi is changed. In this case, the vehicle body image Imi which is changed is stored at the storage portion and the changed vehicle body image Imi is used for the composite image. As the vehicle body image Imi, the cabin interior image captured by the image capture portion 121 which is illustrated as an example in FIG. 8 and/or an image corresponding to the cabin interior image which is changed may be used, for example.

The ECU 11 can set and change a transmittance degree α of the vehicle body image Imi, that is, a composition ratio of the vehicle body image Imi and the vehicle outside image Imo. In a relatively simple example, in a state where the vehicle outside image Imo and the vehicle body image Imi are positioned to each other, in a case where a brightness of the vehicle body image Imi is x1, a brightness of the vehicle outside image Imo is x2 and the transmittance degree is a (0≦α≦1) at each point, a brightness x of the superimposed composite image at each point is x=(1−α)×x1+α×x2. The transmittance degree α can be set at an arbitrary value. The transmittance degree α may be set at an arbitrary value.

On the other hand, in the example illustrated in FIGS. 8 and 9, an image capture portion 12S serving as the image capture portion 12 and capturing or imaging the lateral side of the vehicle 1, that is, the lateral side of the outside of the vehicle, and the image capture portion 12R serving as the image capture portion 12 and capturing the rear side of the vehicle 1, that is, the rear side of the outside of the vehicle cabin are provided at the vehicle body 2. Each of the image capture portions 12S and 12R may capture an image including both the rear side of the vehicle 1 and the lateral side of the vehicle 1. The image capture portion 12S is provided at each of the right side and the left side of the vehicle body 2, and the image capture portions 12R are provided at the rear end portion 2b of the vehicle body 2. For example, the image capture portion 12S may be provided at a door mirror and the image capture portion 12R may be provided at a rear hatch. For example, the image capture portion 12 may be provided at a left end of the rear end portion 2b of the vehicle body 2 and a right end of the rear end portion 2b of the vehicle body 2, which is not shown. In addition, the image capture portion 12 capturing or imaging at least one of the inside the vehicle cabin and the outside of the vehicle cabin may be provided in the vehicle cabin. In addition, in a case where the plural image capture portions 12 are provided, the image capture ranges of the respective plural image capture portions 12 may be different from each other in an upper and lower direction. In addition, each image capture portion 12 may be a wide-angle lens or a fish-eye lens.

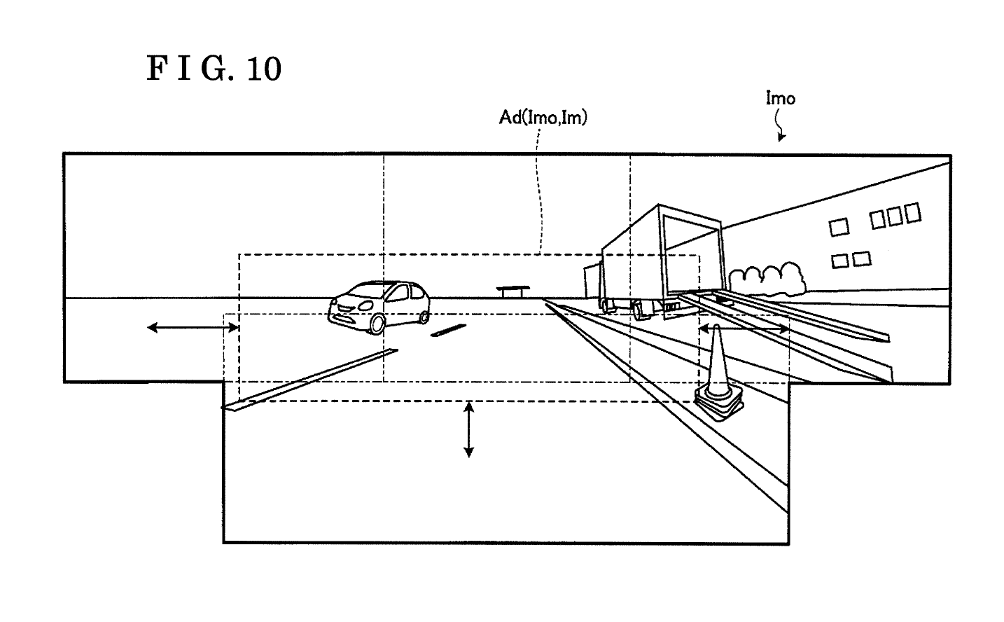

In a case where the plural image capture portions 12 are provided at the vehicle body 2 as illustrated in FIGS. 8 and 9, the ECU 11 composes, with a known technique, the images captured or taken at the plural image capture portions 12, thereby obtaining a series of vehicle outside image Imo illustrated as an example in FIG. 10. The vehicle outside image Imo can be a panoramic image. In this case, the plural image capture portions 12 capture images of a relatively wide range of the rear side and the lateral side of the vehicle 1 so that the vehicle outside image Imo at each position in the relatively wide range is displayed at the display portion 10a. As illustrated in FIG. 10, a portion in the wide range is used for the composite image serving as the output image Im, that is, the portion in the wide range is displayed.

In addition, the ECU 11 can change a display range Ad of the output image Im and the vehicle outside image Imo, depending on the situation of the vehicle 1. The ECU 11 can use detection results and/or instruction signals of various sensors, for example as a signal or data which serve as trigger for changing the display range Ad. The detection results are, for example, detection results of a non-contact measurement apparatus 13, a steering angle sensor 14 for a front wheel, a steering angle sensor 15a of a rear wheel steering system 15, a GPS 16 (global positioning system), a wheel speed sensor 17, a brake sensor 18a of a brake system 18, an accelerator sensor 19, a torque sensor 20a of a front wheel steering system 20 and/or a shift sensor 21 which are illustrated in FIG. 1. The instruction signals are, for example, instruction signals obtained from a direction indicator 22 and/or an operation input portion 24b. The instruction signal can also be referred to as a control signal, a switching signal, an operation signal, an input signal and/or instruction data, for example.

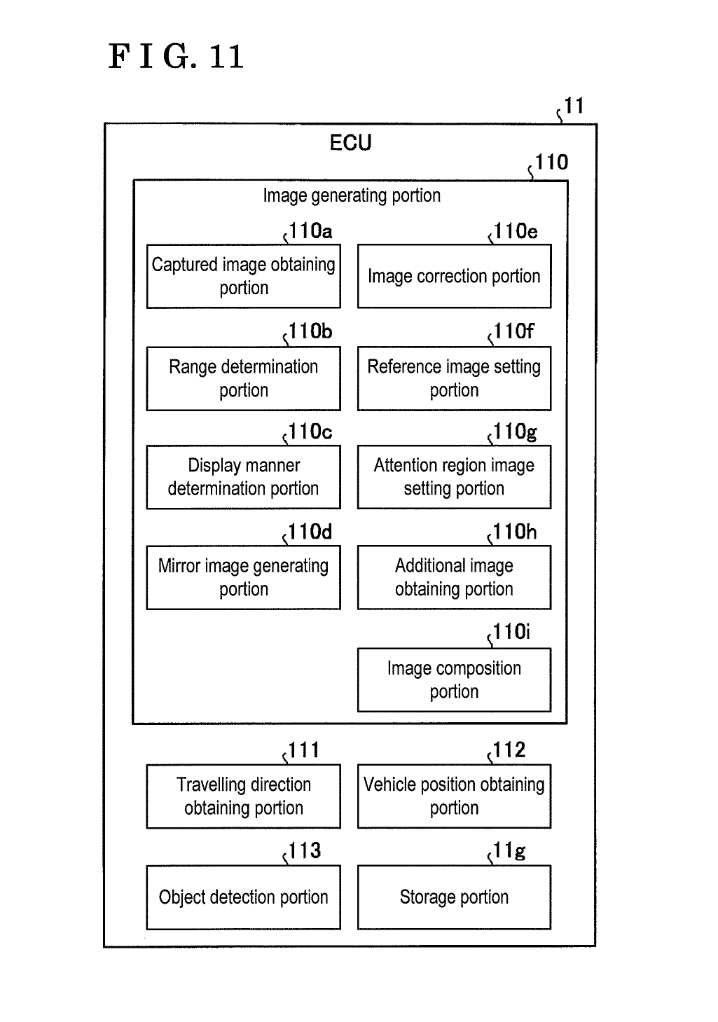

In addition, the ECU 11 can set and change the display range Ad of the output image Im and the vehicle outside image Imo, and/or the transmittance degree α, a color (hue), a brightness and/or intensity of the vehicle body image Imi, in accordance with, for example, a travelling direction of the vehicle 1 which is obtained by a travelling direction obtaining portion 111, the position of the vehicle 1 which is obtained by a vehicle position obtaining portion 112 and/or a detection result by an object detection portion 113 which are illustrated in FIG. 11. In addition, in a case where the vehicle body image Imi is the line image, the ECU 11 may set and/or change the thickness of the outline Lo of the vehicle body image Imi and/or presence and absence of shading of the outline Lo, for example.

As illustrated in FIG. 1, electric components included in the image display system 100 are electrically or communicably connected via an in-vehicle network 23, for example. The electric components are, for example, the non-contact measurement apparatus 13, the steering angle sensor 14, the steering angle sensor 15a, the GPS 16, the wheel speed sensor 17, the brake sensor 18a, the accelerator sensor 19, the torque sensor 20a, the shift sensor 21, the direction indicator 22 and the operation input portion 24b. The in-vehicle network 23 is, for example, a CAN (controller area network). The respective electric components may be electrically or communicably connected via other than the CAN.

The non-contact measurement apparatus 13 is, for example, sonar and/or a radar emitting ultrasonic sound waves and/or electric waves, and catching reflected waves thereof. The ECU 11 can measure presence and absence of the object B and/or the distance to the object B, on the basis of the detection result of the non-contact measurement apparatus 13. The object B corresponds to an obstacle positioned around the vehicle 1 as illustrated in FIG. 2, for example. That is, the non-contact measurement apparatus 13 is an example of a distance measurement portion and an object detection portion.

The steering angle sensor 14 is a sensor which detects a steering amount of a steering wheel serving as a steering portion and being not shown. The steering angle sensor 14 is configured by using, for example, a Hall element. The steering angle sensor 15a is a sensor detecting a steering amount of a rear wheel 3R, and is configured by using, for example, a Hall element. The steering amount is detected as a rotation angle, for example.

The wheel speed sensor 17 is a sensor detecting a rotation amount and/or the number of rotations per unit time of the wheel 3 (3F, 3R), and is configured by using, for example, a Hall element. The ECU 11 can calculate, for example, an amount of movement of the vehicle 1 on the basis of data obtained from the wheel speed sensor 17. The wheel speed sensor 17 may be provided at the brake system 18.

The brake system 18 is, for example, an ABS (anti-lock brake system) restricting the brake from being locked, an antiskid system (ESC: electronic stability control) restricting the vehicle 1 from skidding during cornering, an electric brake system increasing a brake force and/or a BBW (brake by wire). The brake system 18 applies a braking force to the wheel 3 via an actuator that is not shown, and decelerates the vehicle 1. The brake sensor 18a is, for example, a sensor detecting an operation amount of a brake pedal.

The accelerator sensor 19 is a sensor detecting an operation amount of an accelerator pedal. The torque sensor 20a detects torque applied by the driver to the steering portion. The shift sensor 21 is, for example, a sensor detecting a position of a movable portion of a speed change operation portion, and is configured by using a displacement sensor, for example. The movable portion is a lever, an arm and/or a button, for example. The configurations, the arrangements and/or the manners of electrical connection of the various sensors and/or actuators which are described above are examples, and may be set and/or changed in various ways. The direction indicator 22 outputs a signal which instructs turning on and off, and blinking of a light for a direction indicator.

The display portion 10a can be covered with the transparent operation input portion 10b. The operation input portion 10b is a touch panel, for example. The occupant and the like can visually recognize the image displayed on a display screen of the display portion 10a via the operation input portion 10b. In addition, the occupant and the like can perform various operation inputs at the image display system 100 via operations by touching, pushing and/or moving the operation input portion 10b with, for example, a finger at a position corresponding to the image displayed on the display screen of the display portion 10a. The housing 10 may be provided with an operation input portion 10c separately from the operation input portion 10b. In this case, the operation input portion 10c can be configured as a push button, a switch or a tab, for example.

In addition, another display portion 24a, which is provided separately from the display portion 10a, and/or an audio output apparatus 24c are provided inside the vehicle. The display portion 24a is, for example, an LCD or an OELD. The audio output apparatus 24c is, for example, a speaker. Further, the display portion 24a is covered with the transparent operation input portion 24b. The operation input portion 24b is, for example, a touch panel. The occupant and the like can visually recognize an image displayed on a display screen of the display portion 24a via the operation input portion 24b. In addition, the occupant and the like can perform operation inputs via operations by touching, pushing and/or moving the operation input portion 24b with, for example, a finger at a position corresponding to the image displayed on the display screen of the display portion 24a. For example, the display portion 24a, the operation input portion 24b and/or the audio output apparatus 24c may be provided at a monitor apparatus 24 positioned at a central portion of a dashboard in the vehicle width direction, that is, in a right and left direction. The monitor apparatus 24 may be provided with an operation input portion not shown and including, for example, a switch, a dial, a joystick and/or a push button. The monitor apparatus 24 can be used also as a navigation system and/or an audio system. The ECU 11 can cause an image similar to the image on the display portion 10a to be displayed on the display portion 24a of the monitor apparatus 24.

The ECU 11 includes a CPU 11 a (central processing unit), a ROM 11b (read only memory), a RAM 11c (random access memory), the SSD 11d (solid state drive), a display control portion 11e and/or an audio control portion 11f, for example. The SSD 11d may be a flash memory. The CPU 11a can perform various calculations. The CPU 11a can read out program installed on and stored in a non-volatility memory unit including, for example, the ROM 11b and/or SSD 11d, and can perform calculation processing in accordance with the program. The RAM 11c temporarily stores various data used in the calculations at the CPU 11a. In addition, the SSD 11d is a rewritable non-volatility memory unit and can store data even in a case where a power supply of the ECU 11 is turn off. In addition, out of the calculation processings performed at the ECU 11, the display control portion 11e can perform mainly image processing using image data obtained at the image capture portion 12 and/or image processing of image data to be displayed on the display portions 10a, 24a. The audio control portion 11f can mainly process audio data outputted at the audio output apparatus 24c, out of the calculation processings performed at the ECU 11. For example, the CPU 11a, the ROM 11b and/or the RAM 11c may be integrated in the same package. In addition, the ECU 11 may be configured in a manner that, for example, other logical operation processor and/or a logic circuit including a DSP (digital signal processor) are used instead of the CPU 11a. In addition, an HDD (hard disk drive) may be provided instead of the SSD 11d, and the SSD 11d and/or the HDD may be provided separately from the ECU 11.

In addition, in the embodiment, for example, the output image Im corresponding to the mirror image of the rearview minor is displayed on the display portion 10a by the image processing of the ECU 11. In this case, for example, a function, a coefficient, a constant and data which perform coordinate conversion from the vehicle outside image Imo to the output image Im corresponding to an image or mapping at the rearview minor can be obtained by actually obtaining positions of plural markers actually arranged outside and/or inside the vehicle, the positions which are in the image or mapping at the rearview minor, and/or by performing calibration by image capturing, and/or by performing geometric calculation. The function may be a conversion equation and/or a conversion matrix, for example. For example, the output image Im includes an image resembling the image or mapping at the rearview mirror, images of which positions are adjusted and/or an image that is adapted. For example, also a composition position, a size and a shape of the vehicle body image Imi can be obtained by actually obtaining the positions of the plural markers actually arranged outside and/or inside the vehicle, the positions which are in the image or mapping at the rearview mirror, and/or by performing the calibration by the image capturing, and/or by performing geometric calculation.

In addition, in the embodiment, for example, the ECU 11 functions as at least part of the image display control apparatus by cooperation with the hardware and the software (program). That is, in the embodiment, as illustrated in FIG. 11, the ECU 11 functions as an image generating portion 110, the travelling direction obtaining portion 111, the vehicle position obtaining portion 112, the object detection portion 113, a captured image obtaining portion 110a, a range determination portion 110b, a display manner determination portion 110c, a mirror image generating portion 110d, an image correction portion 110e, a reference image setting portion 110f, an attention region image setting portion 110g, an additional image obtaining portion 110h, an image composition portion 110i, in addition to the display control portion 11e and/or the audio control portion 11f which are illustrated in FIG. 1, for example. The image generating portion 110 is, for example, the CPU 11a, and a storage portion 11g is, for example, the SSD 11d. The storage portion 11g stores therein data used in the calculation and/or a calculation result, for example. At least part of the image processings performed at the image generating portion 110 may be performed at the image correction portion 110e. Each of the portions of FIG. 11 may correspond to module of program or may be configured as hardware. The configuration of the ECU 11 illustrated in FIG. 1 and FIG. 11 is an example.

The travelling direction obtaining portion 111 can obtain the travelling direction of the vehicle 1 on the basis of the detection result of the shift sensor 21, the detection result of the wheel speed sensor 17, a detection result of an acceleration sensor which is not shown, and/or data from another ECU which is not shown. The travelling direction obtaining portion 111 obtains whether the vehicle 1 is moving forward or is moving backward.

The vehicle position obtaining portion 112 can obtain the position of the vehicle 1 on the basis of, for example, a wheel speed detected by the wheel speed sensor 17, a steering angle detected by the steering angle sensors 14, 15a, data from the GPS 16, a detection result of the non-contact measurement apparatus 13, an image processing result of the vehicle outside image Imo which the image capture portion 12 has obtained, and/or data from another ECU which is not shown. The position of the vehicle 1 may be, for example, a current position and/or a relative position relative to a target position, in the system.

The object detection portion 113 can detect the object B outside the vehicle by performing the image processing on the vehicle outside image Imo generated at the image generating portion 110, for example. For example, the object B is a vehicle, an object and/or a person. At the detection of the object B, for example, pattern matching can be used. In addition, the object detection portion 113 can detect the object B outside the vehicle from data obtained from the non-contact measurement apparatus 13, and can detect the object B outside the vehicle from a result of the image processing performed on the vehicle outside image Imo and the data obtained from the non-contact measurement apparatus 13. In addition, the object detection portion 113 may obtain the distance from the vehicle 1 to the object B on the basis of the result of the image processing of the vehicle outside image Imo or the data obtained from the non-contact measurement apparatus 13.

The captured image obtaining portion 110a obtains the vehicle outside image Imo captured or taken at at least one of the image capture portions 12. In a case where the plural image capture portions 12 are provided, the captured image obtaining portion 110a can join the plural captured images (for example, three images) captured at the plural image capture portions 12 to each other by composing boundary portions of the plural captured images, thereby creating a continuous series of vehicle outside image Imo.

The range determination portion 110b determines the display range Ad of the vehicle outside image Imo, the display range Ad which is to be used in the output image Im. The range determination portion 110b can set the display range Ad of the output image Im and the vehicle outside image Imo in response to, for example, the traveling direction of the vehicle 1 which is obtained by the travelling direction obtaining portion 111, the position of the vehicle 1 which is obtained by the vehicle position obtaining portion 112 and/or the detection result of the object detection portion 113. In addition, the range determination portion 110b may determine the display range Ad in response to a detection result, a signal and/or data of other sensor and/or device. The other sensor and/or device include, for example, the non-contact measurement apparatus 13, the steering angle sensors 14, 15a, the GPS 16, the wheel speed sensor 17, the brake sensor 18a, the accelerator sensor 19, the torque sensor 20a, the shift sensor 21 and/or the direction indicator 22.

The display manner determination portion 110c determines the display manner of the output image Im at the display portions 10a and 24a. For example, the display manner determination portion 110c can set and change the display manner of the output image Im in accordance with the travelling direction of the vehicle 1 which is obtained by the travelling direction obtaining portion 111, the position of the vehicle 1 which is obtained by the vehicle position obtaining portion 112 and/or the detection result of the object detection portion 113. In addition, the display manner determination portion 110c may set and change the display manner of the output image Im in accordance with a detection result, a signal and/or data of other sensor and/device. The other sensor and/or device include, for example, the non-contact measurement apparatus 13, the steering angle sensors 14, 15a, the GPS 16, the wheel speed sensor 17, the brake sensor 18a, the accelerator sensor 19, the torque sensor 20a, the shift sensor 21 and/or the direction indicator 22. In addition, the display manner determination portion 110c can set and change the transmittance rate a, the color, the brightness and/or the intensity or saturation of the vehicle body image Imi, for example. In a case where the cabin interior image is included in the composite image, the display manner determination portion 110c can set and change, for example, transmittance of the cabin interior image.

The mirror image generating portion 110d can create mirror images of the captured image, the vehicle outside image Imo or the output image Im. The mirror image generating portion 110d may create the mirror image at any phase as long as the vehicle outside image Imo serving as the mirror image of the captured image is included in the output image Im.

The image correction portion 110e corrects the captured image captured at the image capture portion 12. The image correction portion 110e can correct distortion of the captured image captured at the image capture portion 12, for example. In a case where the image capture portion 12 is the wide-angle lens or the fish-eye lens, the farther from a center of the image, the larger the distortion of the image is. Thus, the image correction portion 110e corrects the captured image by performing, for example, the coordinate conversion and/or a complementing processing, so that the image includes a less feeling of strangeness when being displayed in an angle of view of a rectangle. In addition, the image correction portion 110e can perform a processing converting a visual point of the captured image captured at the image capture portion 12. For example, in a case where a difference between an image point of the image capture portion 12 and the visual point of the image or mapping at the rearview mirror is large, the image correction portion 110e corrects the captured image so that the captured image comes close to or resembles the image at a more forward visual point, for example, at the visual point of the image or mapping at the rearview mirror, by performing, for example, the coordinate conversion and/or the complementing processing to obtain the image providing less feeling of strangeness. The coordinate conversion is provided by, for example, a map and/or a function. The correction of the vehicle outside image Imo by the image correction portion 110e does not need to be completely positioned to the mirror image in a case where the rearview mirror is provided. In addition, the image correction portion 110e can conduct correction other than the distortion correction and/or the visual point conversion processing.

The reference image setting portion 110f sets the reference image included in the output image Im. The reference image is an image serving as a guide or indication of a position at the rear side of the vehicle, and is an image corresponding to a position away from the vehicle 1 in the rear direction and/or an image representing a shape of the rear portion of the vehicle body 2, for example. For example, by the operation input performed by the occupant including the driver at the operation input portions 10b, 10c, 24b, the reference image setting portion 110f can choose and set the reference image to be included in the output image Im from among plural candidate reference images that are pre-stored. In addition, the reference image setting portion 110f can set and change the reference image in accordance with, for example, the travelling direction of the vehicle 1 which is obtained by the travelling direction obtaining portion 111, the position of the vehicle 1 which is obtained by the vehicle position obtaining portion 112 and/or the detection result of the object detection portion 113. In addition, the reference image setting portion 110f may set and change the reference image in response to, for example, a detection result, a signal and/or data of other sensor and/or device. The other sensor and/or device include, for example, the non-contact measurement apparatus 13, the steering angle sensors 14, 15a, the GPS 16, the wheel speed sensor 17, the brake sensor 18a, the accelerator sensor 19, the torque sensor 20a, the shift sensor 21 and/or the direction indicator 22. Data indicating the reference image to be set or changed in response to each parameter can be stored at the storage portion 11g.

The attention region image setting portion 110g sets an attention region image to be included in the output image Im. The attention region image is an image positioned at least one of the right side and the left side of the reference image and indicating an attention region corresponding to an obliquely rear side of the vehicle 1. The attention region image is set as a transmissive image transmitting the vehicle outside image Imo, for example. For example, by the operation input performed by the occupant including the driver at the operation input portions 10b, 10c, 24b, the attention region image setting portion 110g can choose and set the attention region image to be included in the output image Im from among plural candidate attention region images that are stored in advance. In addition, the attention region image setting portion 110g can set and change the attention region image in accordance with, for example, the travelling direction of the vehicle 1 which is obtained by the travelling direction obtaining portion 111, the position of the vehicle 1 which is obtained by the vehicle position obtaining portion 112 and/or the detection result of the object detection portion 113. In addition, the attention region image setting portion 110g may set and change the attention region image in response to a detection result, a signal and/or data of other sensor and/or device. The other sensor and/or device include, for example, the non-contact measurement apparatus 13, the steering angle sensors 14, 15a, the GPS 16, the wheel speed sensor 17, the brake sensor 18a, the accelerator sensor 19, the torque sensor 20a, the shift sensor 21 and/or the direction indicator 22. Data indicating the attention region image to be set or changed in response to each parameter can be stored at the storage portion 11g.

The additional image obtaining portion 110h obtains an image to be included in the output image Im separately from the vehicle outside image Imo. In the embodiment, an image which is included in the output image Im and is not the vehicle outside image Imo is referred to as the additional image. The additional image includes various images including, for example, the vehicle body image Imi, the reference image, the attention region image, an image of a frame line on the road surface, an image of an object, an image indicating the travelling direction, an image indicating the target position, an image indicating a trajectory in the past, an intensified display of the object detected by the object detection portion 113 and an image of a letter or character. In addition, the additional image obtaining portion 110h can obtain the additional image corresponding to, for example, the travelling direction of the vehicle 1 which is obtained by the travelling direction obtaining portion 111, the position of the vehicle 1 which is obtained by the vehicle position obtaining portion 112, an object detected at the object detection portion 113, the display range Ad determined at the range determination portion 110b and/or the display manner determined at the display manner determination portion 110c. In addition, as the additional image, the additional image obtaining portion 110h may obtain the cabin interior image based on the image capture portion 121 (refer to FIGS. 8 and 9, for example) capturing or imaging the vehicle inside. Plural additional images can be stored at, for example, the storage portion 11g. Data identifying the additional image in accordance with a value of each parameter can be stored at, for example, the storage portion 11g.

The image composition portion 110i composes or synthesizes the vehicle outside image Imo and the additional image, thereby generating the output image Im. In a case where the cabin interior image is included as the additional image, the cabin interior image where a window portion is taken out by an image processing can be superimposed as the transmissive image at the image composition portion 110i.

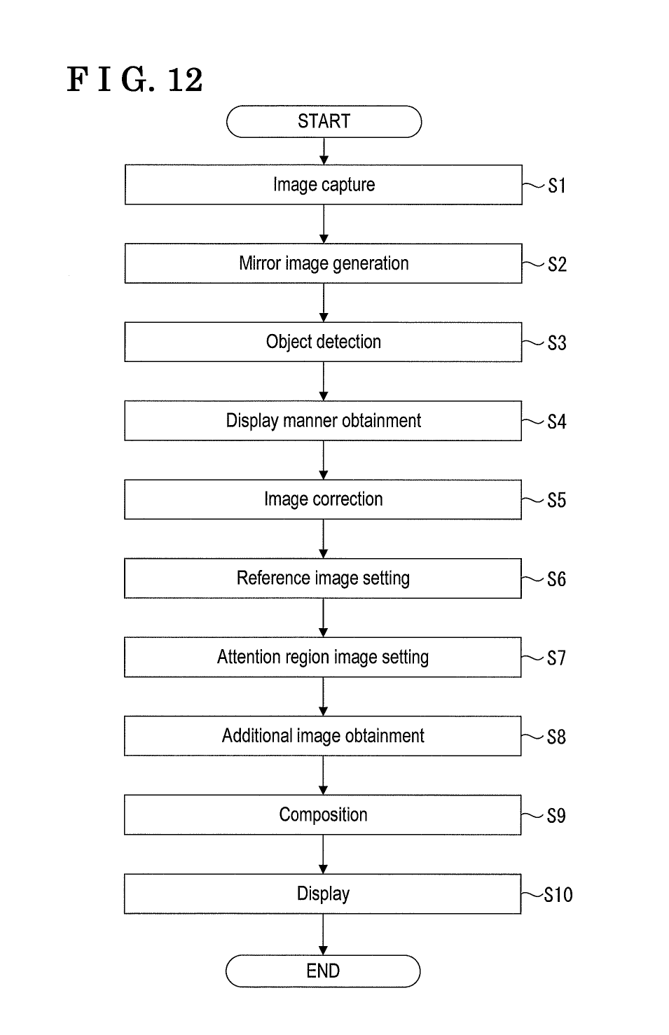

The image display system 100 related to the embodiment can perform the processings in a procedure shown in FIG. 12, for example. First, the captured image obtaining portion 110a obtains the image that the image capture portion 12 captures or images (S1). Next, the mirror image generating portion 110d generates the mirror image of the image captured by the image capture portion 12 (S2). Next, the object detection portion 113 detects the object (S3). Next, the image correction portion 110e obtains the display manner set at the display manner determination portion 110c (S4), and corrects the vehicle outside image Imo according to the obtain display manner (S5). The reference image setting portion 110f sets the reference image (S6) and the attention region image setting portion 110g sets the attention region image (S7). Next, the additional image obtaining portion 110h obtains the additional image (S8), and the image composition portion 110i composes the additional image obtained at the additional image obtaining portion 110h and the vehicle outside image Imo, and obtains the output image Im (S9). Next, the display control portion 11e controls the display portion 10a such that the output image Im is displayed (S10).

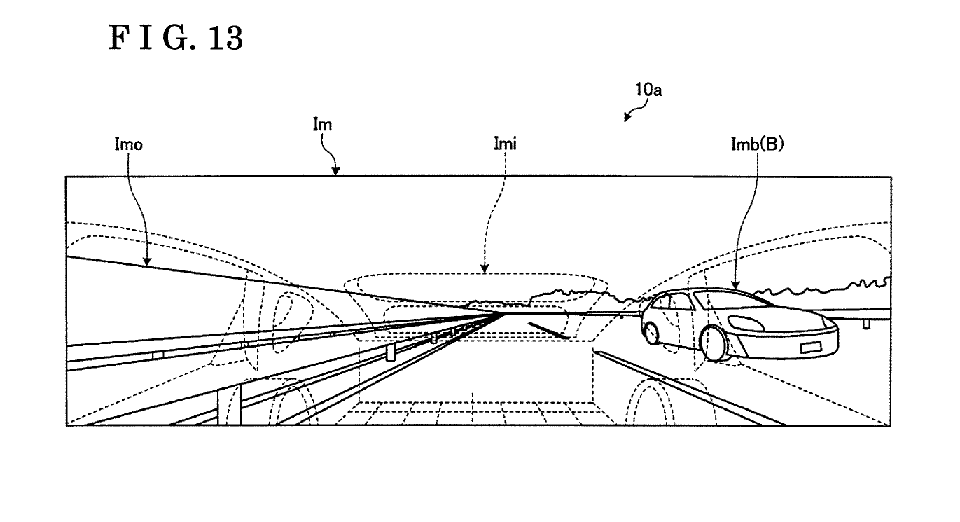

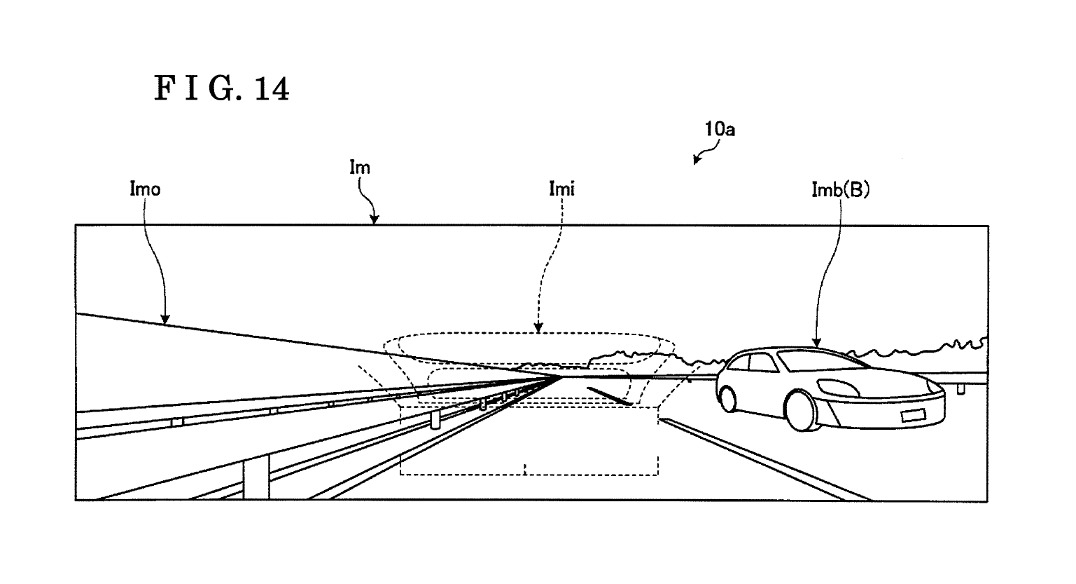

Examples of the output image Im are illustrated in FIGS. 13 to 16. As illustrated in FIGS. 13 to 16, the reference image setting portion 110f can set various reference images included in the output image Im. The reference image is an example of the additional image. In the example of FIG. 13, the vehicle body image Imi representing portions which respectively correspond to the rear portion, the side portion and a bottom portion of the vehicle body 2 is included as the reference image. On the other hand, in the example of FIG. 14, the vehicle body image Imi corresponding only to the rear portion of the vehicle body 2 is included as the reference image. The reference image setting portion 110f can choose and set the reference image to be included in the output image Im from among the plural candidate reference images that are pre-stored, according to the operation input to the operation input portions 10b, 10c, 24b by the occupant including the driver, for example. Thus, the output image Im may include the reference image depending on a taste of the occupant including the driver. In addition, for example, depending on the situation such as weather, the reference image that is easier to be viewed can be set. In the example of FIG. 13, a positional relationship with an image Imb of the object B including, for example, other vehicle, is easily grasped at both the rear side and the lateral side of the vehicle 1. On the other hand, in the example of FIG. 14, as the vehicle body image Imi does not exist at an obliquely lateral side and/or the lateral side of the vehicle 1, the image Imb of the object B is visually recognized more easily.

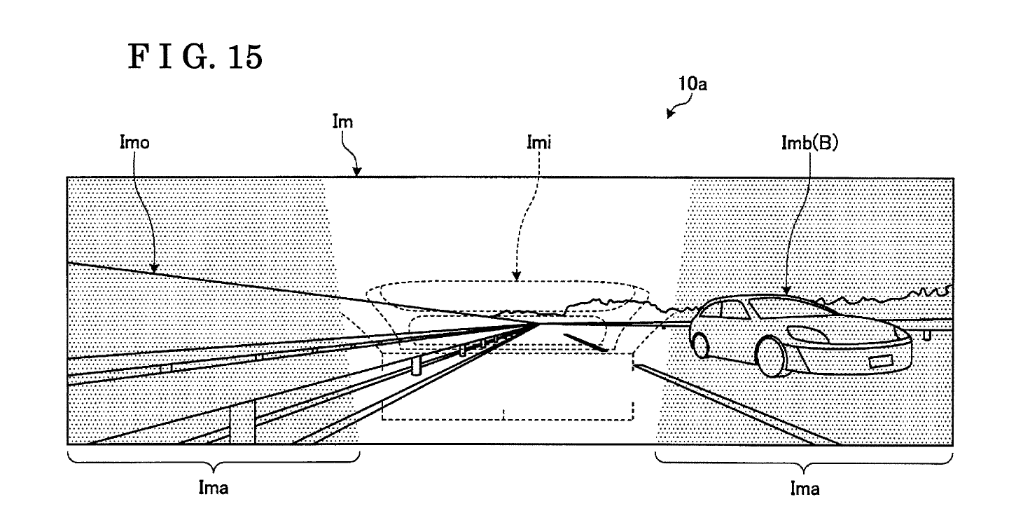

In the example of FIG. 15, an attention region image Ima is added to the output image Im, in addition to the vehicle body image Imi serving as the reference image shown in FIG. 14. In the output image Im, the attention region image Ima is included in at least one of the right side and the left side relative to the reference image. In the example of FIG. 15, the attention region image Ima is included in the output image Im at both right and left sides relative to the vehicle body image Imi serving as the reference image. A central region of the output image Im is a region corresponding to the rear side of the vehicle 1. Regions at the right side and the left side of the output image Im are regions corresponding to the obliquely rear sides of the vehicle 1. In addition, the nearer the image Imb of the object B is positioned to left end portion/right end portion of the output Im, the closer the object B is positioned to a front portion of the vehicle 1. Thus, in the embodiment, because the attention region image Ima corresponding to the attention region at the obliquely rear side of the vehicle 1 is included in the output image Im, the driver may pay more attention to the object B which is positioned closer to the front portion of the vehicle 1. For example, the attention region image Ima can be set as the transmissive image lightly colored so as not to affect the visual recognition of the image Imb of the object B, that is, as an image through which the vehicle outside image Im and/or the image Imb of the object B can be seen. For example, yellow, pink, orange and/or red which are in general easy to draw attention can be set as the color of the attention region image Ima. In addition, in the example of FIG. , the attention region image Ima is arranged at the appropriate region entirely, however, is not limited thereto. For example, the attention region image Ima may be displayed as a frame, or may be indicated with a pattern including oblique lines and/or a dot pattern, for example. In addition, the attention region image Ima may be displayed at a part of the region corresponding to the obliquely rear side of the vehicle 1, for example, at a part of the output image Im at a lower side thereof. The attention region may be a region from an obliquely lateral side of the vehicle 1 to the lateral side of the vehicle 1.

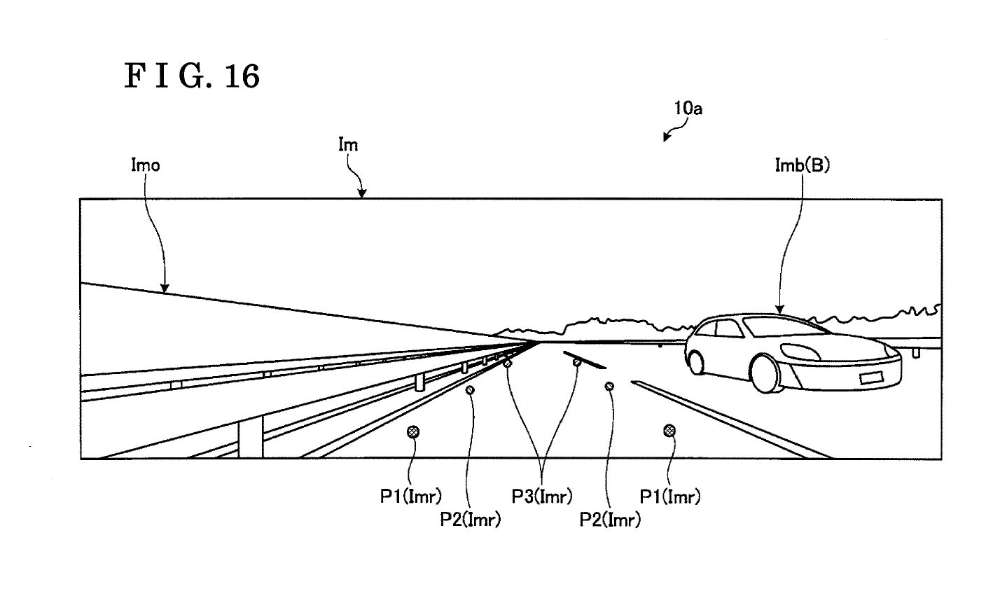

In the example of FIG. 16, as the reference image that differs from the reference images in FIGS. 13 to 15, a rear side position image Imr corresponding to a position at the rear side of the vehicle 1 is added to the output image Im. The rear side position image Imr is an image serving as a guide for a distance from a rear end portion of a floor of the vehicle body 2. In FIG. 16, the rear side position images Imr are drawn as points P1 to P3 serving as six elements. Out of these rear side position images Imr, the two points P1 positioned at the lowest side correspond to, for example, rear end portions of the vehicle body 2 at right and left side ends. The two points P2 positioned at an upper side than the points P1 correspond to, for example, positions at a rear side relative to the rear end portions of the vehicle body 2 at the right and left side ends by a predetermined distance (2 m, for example). The two points P3 positioned at an upper side than the points P2 correspond to, for example, positions at a rear side relative to the rear end portions of the vehicle body 2 at the right and left side ends by a predetermined distance (4 m, for example). Such rear side position images Imr are included in the output image Im, and thus the occupant including the driver recognizes the relative position of the object B including other vehicle positioned at the rear side of the vehicle 1 and/or the size of the object B more precisely or more easily, for example. The reference image may include both the rear side position images Imr and the vehicle body image Imi, although which is not shown in the drawings.

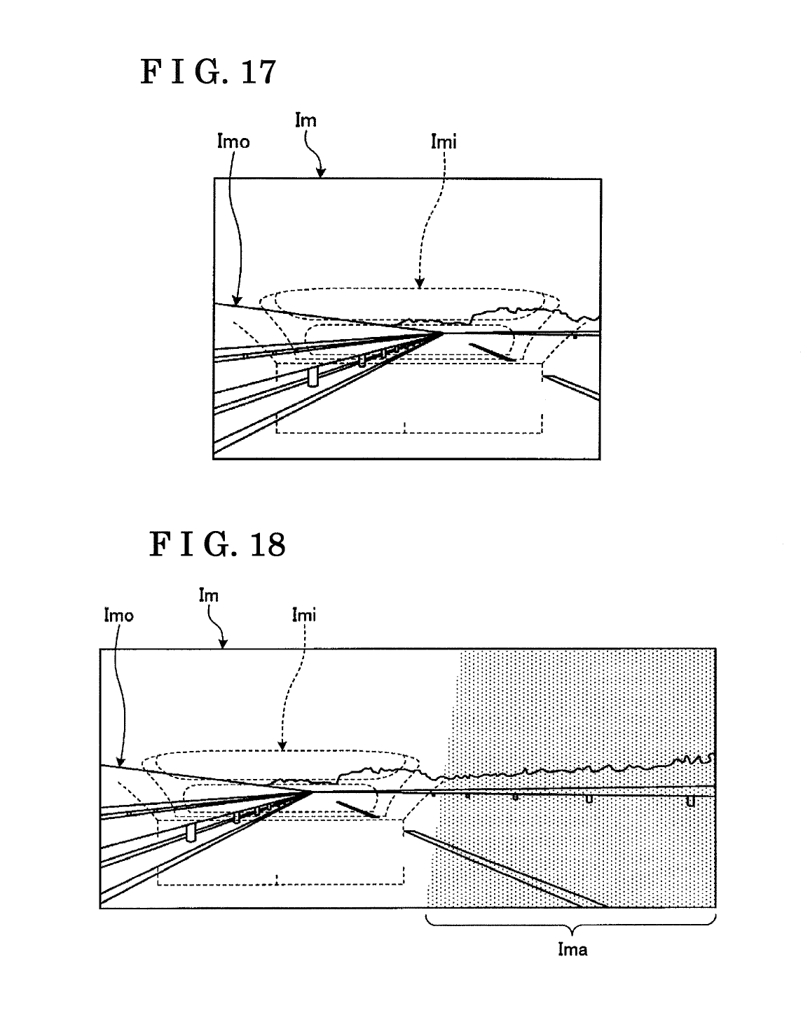

Examples of changes in the output image Im while the vehicle 1 is travelling forward are illustrated in FIGS. 17 to 21. The ECU 11 controls the display portion 10a such that the output image Im, which is shown in each of the drawings as the example, is displayed.

An example of the output image Im corresponding to a relatively small region at the rear side of the vehicle 1 is shown in FIG. 17. The vehicle body image Imi serving as the reference image is added to the output image Im, together with the vehicle outside image Imo. The vehicle body image Imi includes the image corresponding only to the rear portion of the vehicle body 2, but does not include the images corresponding to the side portions of the vehicle body 2. In the example of FIG. 17, the output image Im is displayed only in a region including a relatively narrow width at a central portion of the display portion 10a. The output image Im of FIG. 17 is an example and the output image Im may include a region including a wider width.

The FIG. 18 shows an example of the output image Im which is expanded towards the right side compared to the output image Im of FIG. 17. In addition to the vehicle outside image Imo expanded towards the right side compared to FIG. 17, the vehicle body image Imi serving as the reference image corresponding to the rear portion of the vehicle body 2 and the attention region image Ima positioned at the right side relative to the vehicle body image Imi are included in the output image Im. The ECU 11 can switch the output image Im of FIG. 17 to the output image Im of FIG. 18 on the basis of the operation input by the direction indicator 22 and/or the detection result of the steering angle by the steering angle sensor 14. Specifically, for example, in a case where an operation input which instructs a movement towards the right side is performed at the direction indicator 22 or in a case where the steering angle which is equal to or larger than a predetermined angle (a threshold value) indicating the steering in the right direction is detected by the steering angle sensor 14, the range determination portion 110b sets the display range Ad of the output image Im which is expanded towards the right side compared to FIG. 17 and the attention region image setting portion 110g sets the attention region image Ima at the right side relative to the vehicle body image Imi serving as the reference image. Accordingly, the output image Im added with the attention region image Ima at the right side is displayed at the display portion 10a. Consequently, for example, the occupant such as the driver easily recognizes a region in a turning direction while turning the steering wheel during, for example, a lane change, as a region to which an attention needs to be paid. The example of FIG. 18 is an example and, for example, the vehicle body image Imi and/or the attention region image Ima serving as the reference image may include other display manner. In addition, when the vehicle 1 is steered to the left, the output image Im which is expanded towards the left side is displayed at the display portion 10a, contrary to FIG. 18.

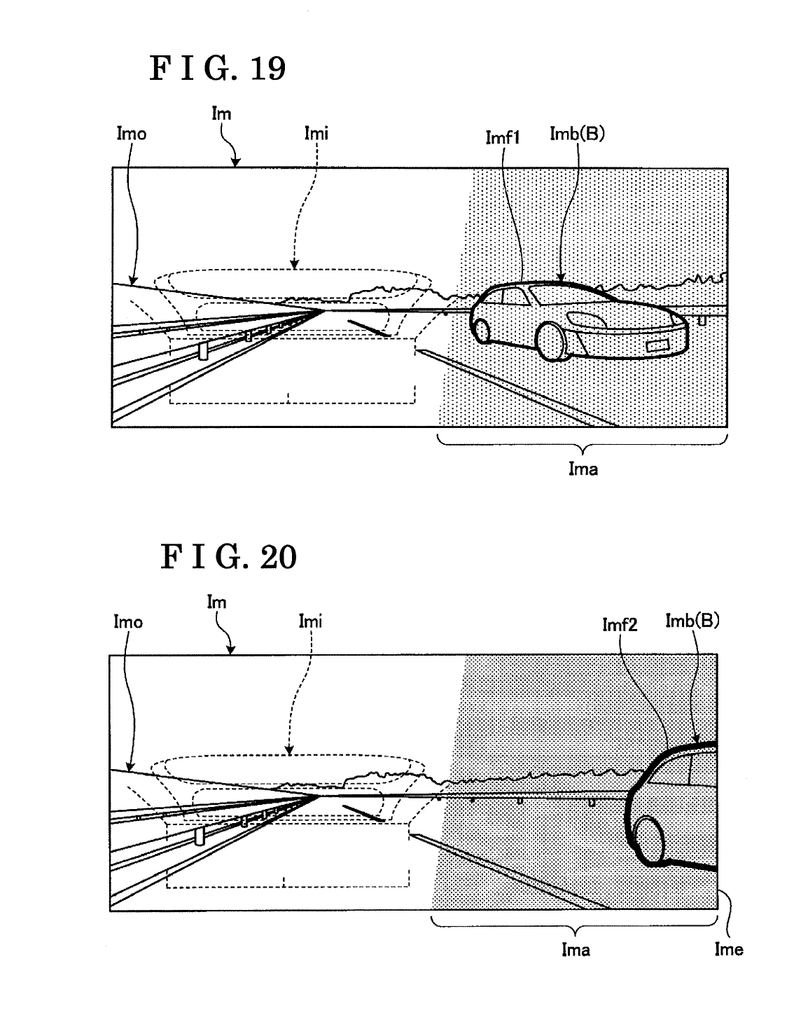

FIG. 19 shows a case as an example, in which the object B such as other vehicle appears at the position corresponding to the attention region image Ima of FIG. 18, and thus the image Imb of the object B is included in the attention region image Ima in the output image Im. In a case where the object B is detected, by the object detection portion 113, at a position overlapping the attention region image Ima in the output image Im, the additional image obtaining portion 110h can add an emphasis image Imf1 to the output image Im, the emphasis image Imf1 which follows along an outer frame of the image Imb of the object B. For example, the emphasis image Imf1 can be set as a frame line including a predetermined thickness and colored with a color which is easy to direct an attention, including, yellow. The emphasis image Imf1 of FIG. 19 is an example. For example, the emphasis image Imf1 may be filled out with a color in a manner that the inside of the frame is transmissive, and a pattern including hatching, meshing and/or halftone screening may be added to the emphasis image Imf1 .

FIG. 20 shows, as an example, the output image Im in a state where the object B including, for example, other vehicle, has moved forward relative to the vehicle 1 from the state shown in FIG. 19. In the state of FIG. 20, the object B has reached a position at which the image Imb of the object B overlaps an end portion Ime at the right side of the output image Im. For example, from the image processing result, the object detection portion 113 can detect the state in which the image Imb is in contact with or overlaps the end portion Ime of the output image Im. In this case, the attention region image setting portion 110g can set the attention region image Ima which is different from FIG. 19. Specifically, for example, the color of the attention region image Ima may be a color different from the attention region image Ima of FIG. 19, and/or a gradation and/or a pattern may be set to the attention region image Ima. In addition, also the additional image obtaining portion 110h can add an emphasis image Imf2 to the output image Im, the emphasis image Imf2 serving as the additional image and being different from the emphasis image Imf1 of FIG. 19. Specifically, for example, a color and/or a type of line of the emphasis image Imf2 may be a color and/or a type of line which are different from the emphasis image Imf1 of FIG. 19. For example, the color of the emphasis image Imf2 may be red and a width of the line of the emphasis image Imf2 may be thicker than a width of the emphasis image Imf1. The attention region image setting portion 110g may change the attention region image Ima as in the example shown in FIG. 20 in a case where a distance of the object B from the vehicle 1 is within a predetermined distance (a threshold value) according to the detection result of the object B by the object detection portion 113.

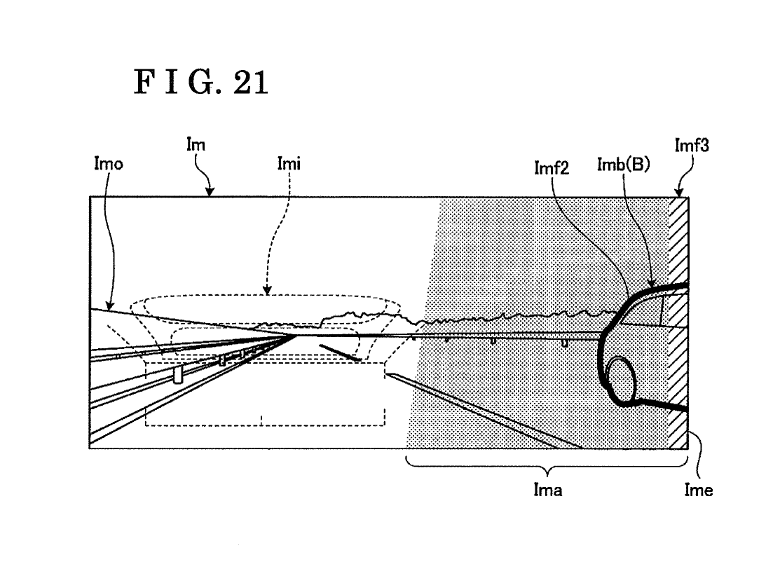

Further, FIG. 21 shows as an example of the output image Im added with an emphasis image Imf3. The additional image obtaining portion 110h can further add the emphasis image Imf3 to the output image Im in the same situation as FIG. 20. The emphasis image Imf3 is an image formed in a belt-like shape including a constant width and is arranged along the end portion Ime at the right side of the output image Im, for example. The emphasis image Imf3 may blink at a predetermined time interval. Due to the output images Im as in FIGS. 20 and 21, the occupant including the driver easily recognizes the situation where the object B including other vehicle is positioned nearer to the front portion of the vehicle 1 and thus more attention is needed.

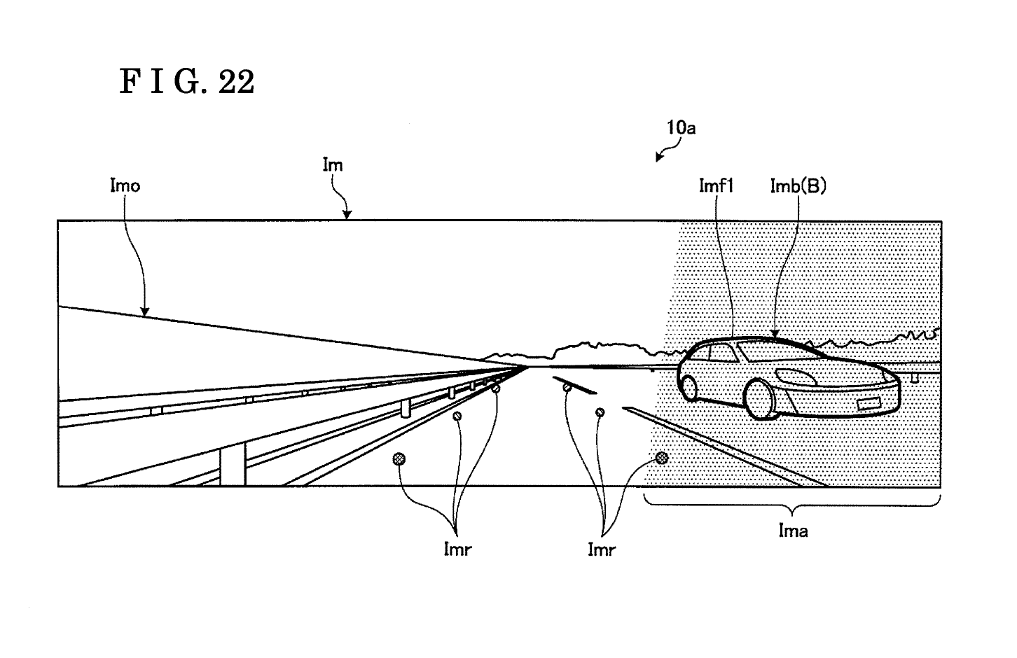

In addition, as shown in FIG. 22, the reference image setting portion 110f may set the rear side position image Imr serving as the reference image added to the output image Im, instead of the vehicle body images Imi of FIGS. 17 to 21. In this case, together with the attention region image Ima, the rear side position image Imr is included in the output image Im.

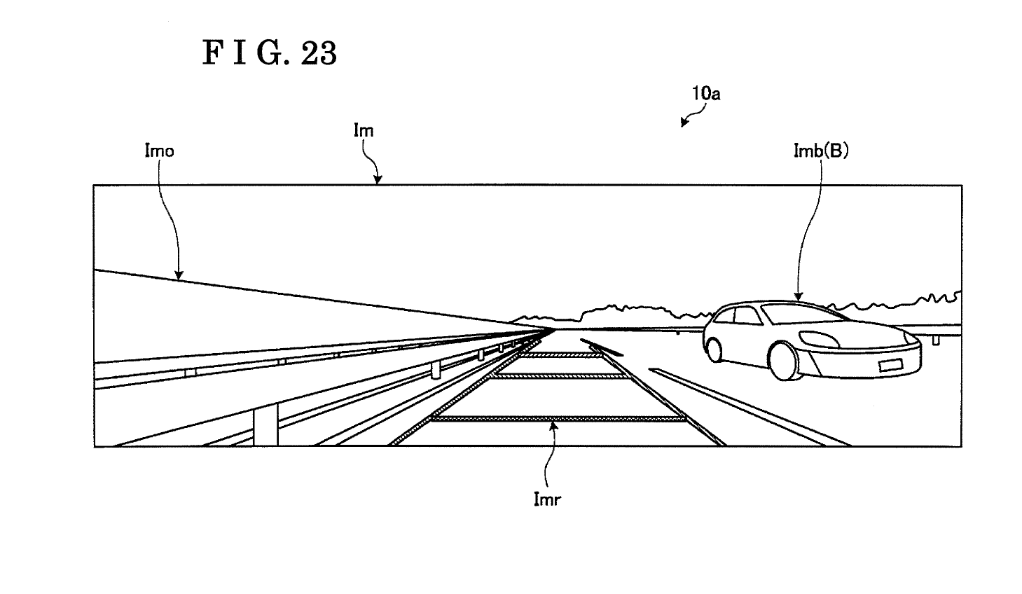

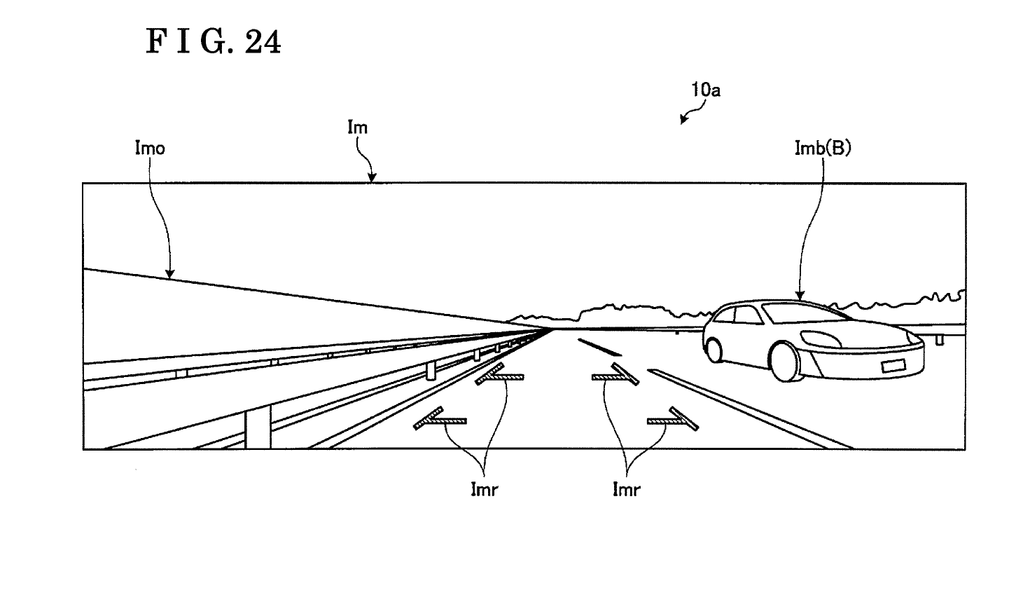

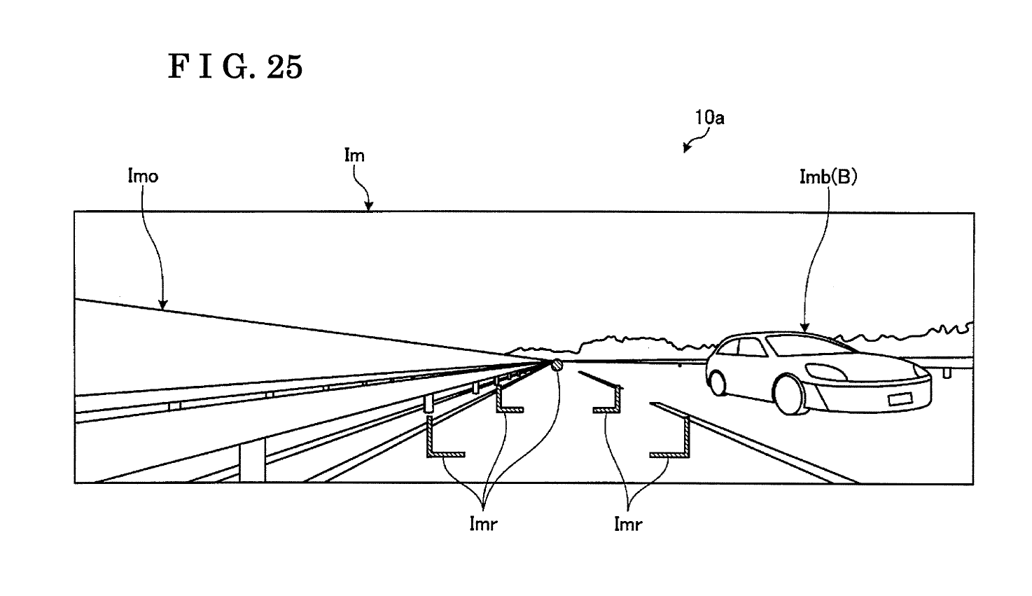

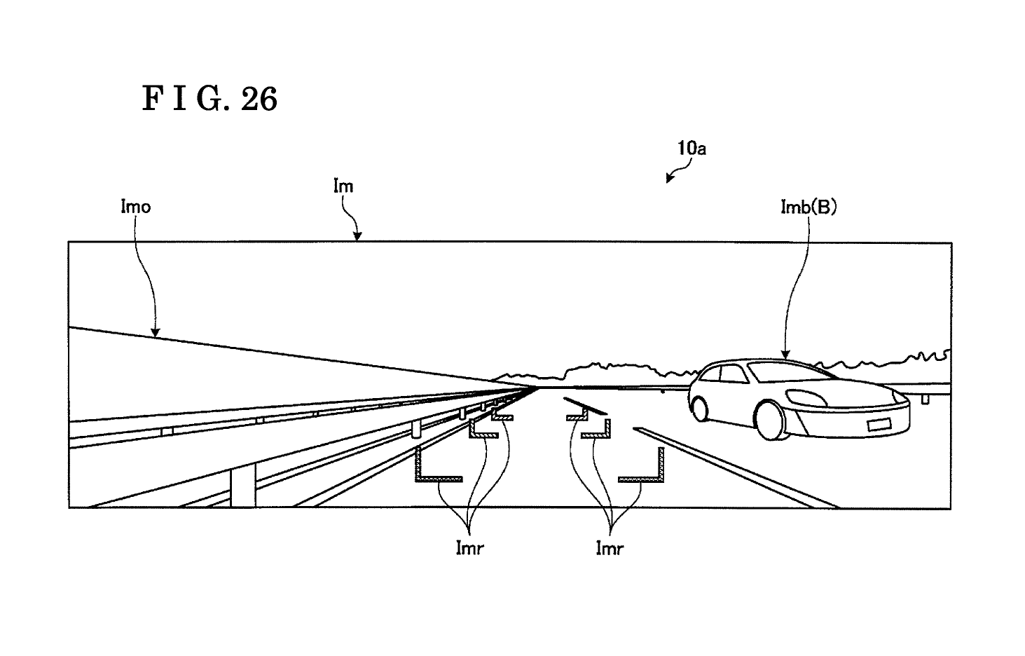

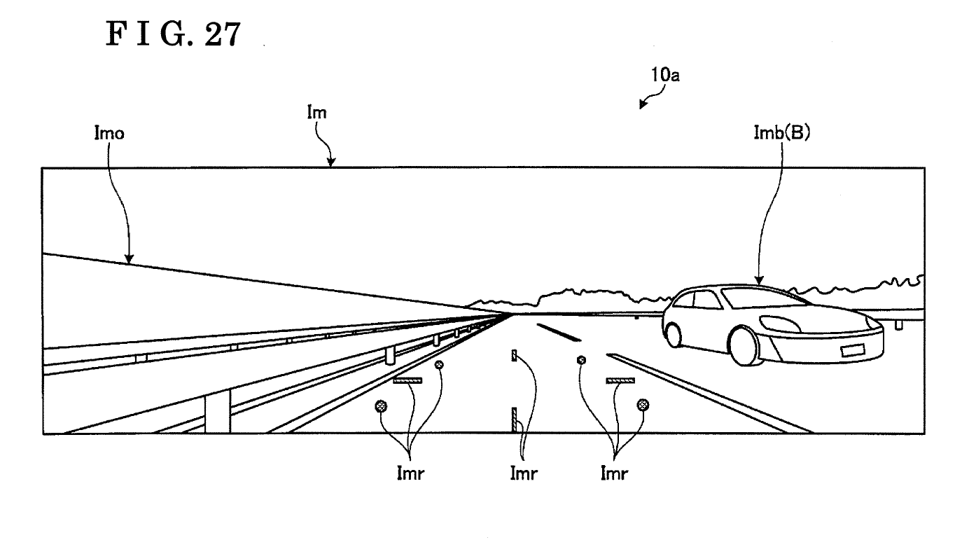

In addition, the reference image setting portion 110f can set the rear side position image Imr in various manners as in shown in FIGS. 23 to 27 as examples. FIG. 23 shows, as an example, the rear side position image Imr of a ladder-structure including lines extended in the vehicle front and rear direction and lines extended in the vehicle width direction. FIG. 24 shows, as an example, the rear side position image Imr including plural T-shaped elements each of which is formed of a line along the vehicle front and rear direction and a line along the vehicle width direction, the lines which are connected to each other. FIG. 25 shows, as an example, the rear side position image Imr including plural L-shaped elements and an element formed in a dot shape. Each of the L-shaped elements is formed of a line along the vehicle width direction and a line along a vehicle upper and lower direction, the lines which are connected to each other. The element formed in the dot shape indicates a distant position. FIG. 26 shows, as an example, the rear side position image Imr including plural L-shaped elements which differ from each other depending on a distance. FIG. 27 shows, as an example, the rear side position image Imr including plural linear elements and plural dot-shaped elements. Due to these rear side position images Imr, the position of the vehicle 1 relative to the object B including other vehicle which is positioned at the rear side of the vehicle 1 is easily grasped. Each of FIGS. 23 to 27 shows the example of the rear side position image Imr, and the rear side position image Imr is not limited thereto.

In addition, by the operation input performed by the occupant including the driver, the range determination portion 110b and/or the display manner determination portion 110c can determine ranges and/or display manners of the vehicle outside image Imo, the vehicle body image Imi, the additional image and/or the output image Im. In this case, for example, the occupant including the driver can visually recognize the output image Im displayed on the display portion 10a in the range and/or the display manner according to his or her taste. The operation input is made by the occupant including the driver by operating the operation input portions 10b, 10c, 24b and/or the steering. The operation input based on the operation of the steering is obtained from the detection result of the steering angle sensor 14.

As described above, in the embodiment, for example, the rear side position image Imr (the reference image) corresponding to the position away from the vehicle 1 in the rear direction can be included in the output image Im (the display image) while the vehicle 1 is moving forward. Thus, according to the embodiment, for example, the relative relationship with the object B, including other vehicle positioned at the rear side relative to the vehicle 1, is readily grasped owing to the rear side position image Imr.

In addition, in the embodiment, for example, the rear side position image Imr includes the plural elements of which the distances from the vehicle 1 are different from each other. Thus, for example, the position of the object B, including other vehicle, from the vehicle 1 is more readily grasped owing to the plural elements.

In addition, in the embodiment, for example, at least one of the rear side position image Imr and the vehicle body image Imi indicating the rear portion of the vehicle body 2 can be included in the output image Im while the vehicle 1 is travelling forward. Thus, for example, the relative relationship with the object B, including other vehicle positioned at the rear side relative to the vehicle 1, is more readily grasped. In addition, for example, the occupant including the driver can choose the rear side position image Imr and the vehicle body image Imi, depending on his or her taste, and can choose the easily viewable image depending on the situation.

In addition, in the embodiment, for example, the attention region image Ima corresponding to the obliquely rear side of the vehicle 1 and indicating the attention region can be included in the output image Im while the vehicle 1 is moving forward. Accordingly, it is easily recognized that the object B including other vehicle exits at the diagonally rear side of the vehicle 1.

In addition, in the embodiment, for example, the attention region image Ima is displayed in a case where the object B including other vehicle is detected at the position corresponding to the attention region image Ima. Accordingly, for example, in a case where the object B does not exist and thus necessity of the attention region image Ima is low, the attention region image Ima is not displayed. Thus, electricity consumption is easily restrained, for example. In addition, for example, by switching the presence and absence of the display of the attention region image Ima, the presence of the object B in the attention region may be more easily grasped.

In addition, in the embodiment, for example, the attention region image Ima changes depending on the position of the object B. Thus, for example, the presence of the object B in the attention region may be more easily grasped compared to a case where the attention region image Ima does not change.

The embodiment of this invention is described above as the example, however, the aforementioned embodiment is the example and does not intend to limit the scope of the invention. The embodiment may be implemented in other various manners. Various omission, replacements, combinations, changes may be made without departing from the scope of the invention. In addition, the configuration and/or shape of each example may be partly switched and be implemented. In addition, a specification (a structure, a kind, a direction, a shape, a size, a length, a width, a thickness, a height, the number, an arrangement, a position, a color and/or a patter, for example) of each configuration and/or shape may be appropriately changed and be implemented.

In addition, the output image (the display image) may be displayed on plural display apparatuses and may be displayed on a display apparatus at a position other than the rearview mirror. The display apparatus may be an apparatus which shows the image on a front window and/or a screen inside the vehicle, for example. The display apparatus may be a display panel provided at a dashboard and/or a center console inside the vehicle, for example. The display panel may be provided at a cockpit module, an instrument panel or a fascia, for example.

### EXPLANATION OF REFERENCE NUMERALS

1 . . . vehicle, 2 . . . vehicle body, 10a . . . display portion (display apparatus), 11 . . . ECU (image display control apparatus), 11e . . . display control portion, 12, 12R . . . image capture portion, 100 . . . image display system, 110 . . . image generating portion, 110f . . . reference image setting portion, 110g . . . attention region image setting portion, 113 . . . object detection portion, Im . . . output image (display image), Imo . . . vehicle outside image, Imr . . . rear side position image (reference image), Imi . . . vehicle body image (reference image), Ima . . . attention region image

1. An image display control apparatus comprising:
an image generating portion generating a display image to be displayed on a display apparatus, the display image including a mirror image of a vehicle outside image based on at least a part of a captured image in which at least a rear side of a vehicle is captured;
a reference image setting portion being capable of setting a reference image corresponding to a position that is away towards the rear side of the vehicle, the reference image being set as an image to be included in the display image while the vehicle is moving forward; and
a display control portion controlling the display apparatus so that the display image is displayed.

2. The image display control apparatus according to claim 1, wherein the reference image setting portion is capable of setting at least one of the reference image corresponding to the position that is away towards the rear side of the vehicle and a reference image showing a rear portion of a vehicle body, as the image to be included in the display image while the vehicle is moving forward.

3. The image display control apparatus according to claim 1, comprising:
an attention region image setting portion being capable of setting an attention region image which is positioned at at least one of a right side and a left side of the reference image in the display image and shows an attention region corresponding to an obliquely rear side of the vehicle, the attention region image being set as an image to be included in the display image.

4. The image display control apparatus according to claim 3, comprising:
an object detection portion detecting an object, and
the attention region image setting portion setting the attention region image in a case where the object is detected at a position corresponding to the attention region by the object detection portion.

5. The image display control apparatus according to claim 4, wherein the attention region image setting portion sets the different attention region image depending on a position of the detected object.

6. An image display system comprising:
an image capture portion capturing at least a rear side of a vehicle;
a display apparatus; and
an image display control apparatus, wherein the image display control apparatus includes:
an image generating portion generating a display image to be displayed on the display apparatus, the display image including a vehicle outside image based on at least a part of a captured image captured by the image capture portion;
a reference image setting portion being capable of setting a reference image showing a position that is away towards a rear side of a vehicle body, the reference image being set as an image to be included in the display image while the vehicle is moving forward; and
a display control portion controlling the display apparatus so that the display image is displayed.
